(19) United States
(12) Patent Application Publication
(10) Pub. No.: US 2026/0228067 A1
(43) Pub. Date: Aug. 6, 2026

(54) DISTRIBUTED COMPUTER SYSTEM AND METHOD FOR ORCHESTRATING MULTI-AGENT COLLABORATION

(71) Applicants: UVUE LTD, Bury St Edmunds (GB); ASSMBL.AI LIMITED, Bury St Edmunds (GB)

(72) Inventors: Humayun Munir Sheikh, Bury St Edmunds (GB); Atilla Bagoly, Bury St Edmunds (GB)

(21) Appl. No.: 19/637,086

(22) Filed: Apr. 2, 2026

Related U.S. Application Data
(63) Continuation-in-part of application No. 17/234,932, filed on Apr. 20, 2021.
(63) Continuation-in-part of application No. 18/318,897, filed on May 17, 2023, now Pat. No. 12,620,019.

(51) Int. Cl. G06F 9/54

(52) U.S. Cl. CPC G06F 9/547; G06F 2209/541

(57) ABSTRACT

Disclosed is distributed computer system for orchestrating multi-agent collaboration comprising plurality of computing nodes communicably coupled via communication network, each computing node comprising at least one agent. System further comprises first agent, of plurality of agents, configured to: receive service request (SR); call large language model(s) to generate structured service data (SSD) for execution of SR; and invoke, via communication channel (CC), at least one second agent using SSD, wherein first and at least one second agents are configured to exchange messages via CC to iteratively evaluate SSD and reach consensus on execution of SR. System further comprises at least one execution agent configured to: execute at least one task corresponding to SSD in response to consensus, wherein at least one agent is configured to: generate output from executed at least one task; and update CC based on output to record completion of at least one task, thereby fulfilling SR.

### TECHNICAL FIELD

The present disclosure relates to distributed computer systems for orchestrating multi-agent collaboration within channel-based communication systems. The present disclosure also relates to computer-implemented methods for orchestrating multi-agent collaboration within channel-based communication systems.

### BACKGROUND

Recent advances in large language model (LLM) technology have enabled multi-agent frameworks where multiple artificial intelligence (AI)-based entities, namely autonomous agents (AAs) or agents, collaborate on tasks. Such frameworks are expected to support interactions among multiple AAs and operate across distributed computing environments. However, an increasing number of participating AAs, exchanged messages, and decision dependencies result in challenges in reliably coordinating multiple agents, maintaining coherent context during extended exchanges, managing evolving execution state, and ensuring predictable fulfilment of complex service requests.

Existing systems employ multi-agent coordination frameworks for handling large-scale deployments of the autonomous agents, multiple user requests and distributing operations among multiple software components. Though such approaches can automate certain forms of task processing, as the number of autonomous agents and the complexity of tasks increase, the centralized control and communication become bottlenecks, leading to performance degradation and inefficiencies. Moreover, coordinating the actions of numerous autonomous agents operating in a decentralized (i.e., distributed) manner becomes increasingly difficult, as existing systems treat autonomous agents as interchangeable computational units without persistent personality, relationship context, or owner representation, thereby impeding the system's ability to effectively solve complex problems. Moreover, when a human interacts with another user's autonomous agent, existing systems fail to dynamically adjust tool access or data visibility based on social relationship with a given autonomous agent.

Additionally, existing systems fail to interpret conversational messages to dynamically discover service requests, and select or discover the relevant agents needed for task execution. Furthermore, existing systems use task queues or workflow engines, thus often lack robust mechanisms for agents to collaborate and exchange information seamlessly through a shared communication channel, limiting their overall problem-solving capabilities.

Therefore, in light of the foregoing technical problems, there exists a need to overcome the aforementioned problems associated with existing multi-agent collaboration systems.

### SUMMARY

The present disclosure seeks to provide a distributed computer system and a computer-implemented method for socially aware multi-agent artificial intelligence (AI) collaboration that enables multiple autonomous AI agents (AAs) with distinct personalities, knowledge graphs, and tool permissions to collaborate with human users and each other in shared communication channels. The present disclosure further seeks to provide a distributed computer system and a computer-implemented method for orchestrating multi-agent collaboration. An aim of the present disclosure is to provide a solution that overcomes at least partially the problems encountered in prior art.

In the context of the present disclosure, orchestration of the service request is performed by one or more agents of the plurality of agents operating within the distributed computer system, and the system provides the execution environment, communication channel, and coordination framework enabling such agent-level orchestration

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a block diagram of a distributed computer system for orchestrating multi-agent collaboration within a channel-based communication system, in accordance with an embodiment of the present disclosure;

FIGS. 2A AND 2B (together FIG. 2 or FIG. 2) show schematic workflows of multi-agent collaboration within a channel-based communication system, in accordance with an embodiment of the present disclosure; and

FIG. 3 is a flowchart depicting steps of a computer-implemented method for orchestrating multi-agent collaboration within a channel-based communication system, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In a first aspect, the present disclosure provides a distributed computer system for orchestrating multi-agent collaboration comprising a plurality of computing nodes communicably coupled via a communication network, each of the computing nodes comprising at least one agent, the system further comprising:
a first agent of a plurality of agents, the first agent configured to:
   receive a service request;
   call at least one large language model (LLM) to generate structured service data for execution of the service request; and
   invoke, via a communication channel, at least one second agent of the plurality of agents using the structured service data,
wherein the first agent and the at least one second agent are configured to exchange messages via the communication channel to iteratively evaluate the structured service data and reach a consensus on execution of the service request; and
at least one execution agent of the plurality of agents configured to execute at least one task corresponding to the structured service data in response to the consensus,
wherein at least one agent of the plurality of agents is configured to:
   generate an output from the executed at least one task; and
   update the communication channel based on the output to record completion of the at least one task, thereby fulfilling the service request.

The disclosed distributed computer system provides a socially contextualized, multi-agent artificial intelligence (AI) collaboration platform that enables natural language agent discovery and routing via specific identifiers, and maintains persistent social identities for AI agents representing their owners. Moreover, said platform allows safe AI-to-AI interaction within shared human conversational spaces, while preserving conversation context across agent delegation chains. Furthermore, the disclosed system supports cross-network agent discovery and communication. In this regard, the system provides plurality of computing nodes communicably coupled via the communication network, thereby supporting distributed deployment of agents and scalable execution across multiple nodes rather than confining orchestration to a single machine. The first agent as an initiator of orchestration flow ensures controlled engagement of additional agents through a shared coordination medium rather than through isolated ad hoc invocation paths, thereby improving reliability of multi-agent decision making by allowing collaborative refinement before execution proceeds. Moreover, the system ties execution to a shared decision state and thereby reduces conflicting or premature task performance. Furthermore, the system preserves a persistent machine-readable execution record within the same communication channel used for collaboration, thereby improving traceability, state continuity, and downstream control. Thus, the disclosed system produces a synergistic technical effect in which request interpretation, agent discovery and participation, collaborative evaluation, execution gating, output generation, and completion recording are all unified through the structured service data and the communication channel, thereby improving scalability, determinism, coordination reliability, and end-to-end controllability of multi-agent service execution.

The communication channel may comprises a shared data structure maintained in memory of at least one computing node, the shared data structure being configured to store structured messages exchanged between the plurality of agents and to maintain a collaboration state associated with the service request. The structured messages may represent intermediate evaluations, proposed execution actions, or consensus-related information generated during iterative evaluation of the structured service data.

In some embodiments, the iterative evaluation of the structured service data by the first agent and the at least one second agent is performed based on the structured messages stored in the shared data structure of the communication channel, such that each evaluation step is dependent on at least one previously stored message within the communication channel. The iterative evaluation of the structured service data may comprise supplying, to the at least one large language model (LLM), at least a portion of the communication channel state as input. In this regard, the communication channel state comprises one or more structured messages, prior evaluations, intermediate outputs, proposed execution states, and/or collaboration state information stored in the shared data structure. The at least one LLM is configured to process the communication channel state together with the structured service data to generate updated evaluations, responses, or execution-related determinations. Accordingly, each evaluation step performed by the first agent or the at least one second agent is derived from both the structured service data and the communication channel state, such that the LLM operates on an evolving state representation reflecting prior interactions recorded in the communication channel.

The consensus on execution of the service request may be recorded in the shared data structure of the communication channel as a machine-readable consensus state, and execution of the at least one task by the at least one execution agent is triggered in response to the recorded consensus state in the communication channel.

Throughout the present disclosure, the term “distributed computer system” or “system” (as referred to hereafter) refers to an arrangement in which system components are deployed across plurality of computing nodes that communicate over one or more communication networks, rather than being confined to a single local machine. Optionally, the plurality of computing nodes are communicably coupled with each other. Optionally, each of the plurality of computing nodes comprises at least one processor, at least one memory, and a communication interface. The system may be implemented using a distributed computing network architecture, a decentralized (i.e., distributed) computing network architecture, or a hybrid thereof, provided that the system enables coordinated execution of processing operations across the plurality of computing nodes. It will be appreciated that, unless explicitly stated otherwise, the terms “distributed”, “decentralized” and/or “hybrid” network architecture as used herein do not imply any particular ownership structure, control hierarchy, or administrative boundary, and should not be construed as limiting the system to single-owner, multi-owner, centralized, or federated deployments. The aforementioned computing network architectures ensure coverage of both centrally managed and multi-entity implementations while preserving architectural flexibility.

The system is configured to orchestrate, namely, control, coordinate, or manage execution of operations performed by a plurality of computing nodes via a plurality of agents, such that the plurality of agents contribute in a technically ordered manner toward execution of a service request. In this regard, the system provides the system-level execution environment, namely the multi-agent collaboration environment, in which the plurality of agents operate, exchange data, and perform coordinated processing of the service request. The multi-agent collaboration includes technical interaction among multiple agents rather than isolated independent execution by separate software components. The multi-agent collaboration may include exchange of messages, cooperative evaluation of service-related data, coordinated task execution, and updating of shared state or records associated with the service request, over a communication network. As used herein, the term “communication network” refers to one or more wired, wireless, local, wide-area, peer-to-peer, platform-internal, or externally addressable communication infrastructures through which the plurality of computing nodes exchange data. The communication network provides the transport path that enables the plurality of computing nodes to be communicably coupled for transfer of messages, service data, invocation instructions, outputs, state updates, registry queries, or other execution-related information.

It will be appreciated that, in the context of the present disclosure, the term “agent” refers to a software-implemented autonomous execution entity configured to perform one or more tasks and interact with other agents within the distributed computer system (hereafter referred to as “system”), and which may operate using at least one processor and associated memory. Therefore, at least one agent may perform processing, coordination, evaluation, execution, or communication functions associated with the service request.

Herein, the term “module” refers to a processor-executable functional component within an agent that performs a defined internal operation in support of the agent's behavior, wherein a module is not independently operable as a system-level autonomous entity. Accordingly, an agent may comprise one or more modules, and a module may instantiate, configure, or coordinate one or more agents without itself constituting an agent.

The term “autonomous agents” (referred to herein later as “AAs”) as used herein, relates to computational entities or software programs that are designed to perform tasks or make decisions autonomously, without direct human intervention. The AAs have the ability to perceive their environment, analyze information, and take actions based on predefined rules, algorithms, or learning capabilities. Herein, the system comprises a plurality of modular and extensible software modules configured to operate as the AAs and function independently.

Throughout the present disclosure, the term “first agent” refers to a software-implemented autonomous execution entity of (from amongst) a plurality of agents that serves as an entry-point agent for processing the service request and initiating downstream orchestration of execution of the service request. As used herein, the term “plurality of agents” refers to two or more software-implemented autonomous execution entities configured to perform tasks, exchange information, and cooperate in execution of the service request. Optionally, the plurality of agents may be modular and extensible autonomous agents communicably coupled with each other within a distributed software framework. Notably, the first agent is a member of the plurality of agents that initiates interaction with one or more other members, namely, at least one second agent, of the plurality of agents. The first agent is instantiated using at least one computing node of the plurality of computing nodes. Beneficially, in a multi-agent collaboration environment, each of the plurality of agents enables distribution of processing, specialization of execution roles, and collaborative handling of the service request across multiple autonomous execution entities.

The first agent receives or obtains a service request. The term “service request” as used herein refers to a specific action or communication made by a user, typically through a digitalized system, to seek a particular service or assistance. Optionally, the service request can take various forms, such as direct interactions with digital interfaces like voice assistants (such as Siri, Alexa, ChatGPT, and so forth), inputting information into dedicated applications, or entering appointments into personal calendars. Optionally, the service request may include metadata, which is additional information accompanying the request, and is utilized by at least one Large Language Model (LLM) to provide relevant inferences or responses. Optionally, the service request may originate from individuals or authorized entities, including the digital twins or company LLMs, which are empowered to request services on behalf of the clients, such as arranging travel services.

Optionally, the service request includes at least one of: a time needed for providing the service, a price associated with the service, a quality associated with the service, and/or at least one preference associated with the service. For example, the user specifies a parameter (such as, using the graphical user interface associated with a device including at least one of: time, price, quality and/or at least one preference that is required by the user in the provided service. In such an instance, the parameter is provided to the device with the generated service request. In one example, the service request includes the price associated with the service, such as a minimum and maximum price associated with the service.

Optionally, the service request is received from at least one of: a software application executing on a device of a user, a software application executing on a computing device that is communicably coupled to a device of a user, a cloud-based software application, a digital twin of a user, a digital representation of a user, an artificial intelligence model (AI-model) based on a Large Language Model (LLM). Beneficially, these diverse sources broaden the accessibility and flexibility of the system, allowing users to interact with the system through different channels or interfaces.

Optionally, upon receiving the service request, the first agent is configured to generate one or more objectives associated with the service request. The first agent processes the service request (for example, using at least one processor configured to execute various instruction sets to achieve the required objective), to derive structured metadata and leveraging historical metadata corresponding to previously processed service requests stored in a memory. Herein, the objective is defined in the form of the one or more representations providing a machine-processable, context-enriched formulation of the service request suitable for downstream orchestration, task generation, and assignment to autonomous agents.

The term “metadata” as used herein refers to structured descriptive information characterizing attributes of a service request, including but not limited to: a service type (e.g., travel booking, procurement, scheduling), a problem domain identifier, entities involved (e.g., vendor identifiers, destination identifiers), temporal constraints, geographic parameters, cost constraints, user preferences, device/account identifiers, and optionally historical execution outcomes and performance indicators. Such metadata may be extracted from the service request using parsing routines, natural language processing modules, or predefined schema mappings, and may be normalized into structured fields suitable for computational comparison. In this regard, the client agent employs at least one data processing algorithm to match metadata associated with previous service requests with at least one service requested in the current service request.

The term “data processing algorithm” as used herein refers to a processor-executable computational procedure configured to perform comparison, classification, ranking, similarity determination, clustering, or retrieval operations over structured data. Examples of such algorithms include, but are not limited to, rule-based matching algorithms, keyword or token comparison routine algorithms, weighted scoring functions over metadata attributes, vector similarity computations including cosine similarity or Euclidean distance over embedded representations, clustering algorithms, and machine learning-based classifiers.

Moreover, the first agent is configured to call at least one large language model (LLM) to generate structured service data for execution of the service request. Notably, the LLM is an AI model trained on a vast amount of textual data, enabling it to understand and generate human-like language responses. Herein, the software application utilizes the LLM to process the service request and convert the same structured service data. In this regard, when the software application refers the service request to the LLM, the LLM interprets, using natural language processing techniques, unstructured data corresponding to the service request and transforms it into structured data to allow the method to be carried out. The LLM understands the context, identifies key information, and extracts relevant details from the service request. Moreover, once the LLM processes the service request, it transforms the extracted information into structured service data. Optionally, the structured service data is represented as one or more vectors. The one or more vectors capture the essential characteristics or attributes of the service request in a structured format. For example, if the service request is to find a nearby restaurant, the LLM can extract information such as the desired cuisine, location, price range, and any specific dietary restrictions. This information is then converted into a vector representation with each dimension representing a specific attribute (such as cuisine, location, price, and so forth).

Furthermore, the structured service data, in the form of one or more vectors, generated by the LLM is used as an objective associated with the service request. It becomes the refined and structured representation of the user's request, suitable for further processing within the system. For instance, the transformed structured service data vector may be used by other AAs in the system to match the user's preferences with available restaurants, recommend suitable options, or make decisions based on the extracted attributes. The technical effect of referring the service request to the LLM is that it allows for efficient storage, retrieval, and manipulation of the objective within the system, enhancing the system's ability to understand and fulfil the user requests accurately and effectively.

Furthermore, the first agent is configured to invoke, via a communication channel, at least one second agent of the plurality of agents using the structured service data. The invocation is performed by the first agent and targeted at (or received by) the at least one second agent. As used herein, the term “at least one second agent” refers to one or more agents of the plurality of agents other than the first agent that are invoked by the first agent. Accordingly, the first agent initiates the process of orchestration and participation of the at least one second agent through the communication channel using the structured service data. The at least one second agent is invoked using the structured service data that supplies the machine-processable content by which the at least one second agent is engaged, rather than by unrelated or ad hoc information.

As used herein, the term “communication channel” refers to a communication structure or shared coordination medium through which the plurality of agents exchange invocation data, messages, structured service data, outputs, or state-related information. The communication channel serves as a shared data structure and is used for inter-agent interaction and channel updates reflecting progress and completion, thereby supporting consistent information exchange and collaborative execution flow. It may be appreciated that the communication channel is not limited to a newly created channel and may cover an existing or reused channel used for inter-agent interaction.

Beneficially, using the structured service data for invocation preserves continuity between request interpretation and downstream inter-agent execution, thereby reducing ambiguity and improving deterministic coordination. Additionally, invoking via the communication channel enables controlled participation of additional agents in a shared coordination framework for collaborative evaluation and execution of the service request.

Moreover, the first agent and the at least one second agent are configured to exchange messages via the communication channel to iteratively evaluate the structured service data and reach a consensus on execution of the service request. Herein, exchanging messages refer to sending, receiving, processing, and responding to messages containing information relevant to execution of the service request. Optionally, the messages may comprise structured or semi-structured data representing evaluations, proposed actions, intermediate outputs, execution-related parameters, task-related information, or other collaboration information associated with the service request. It may be appreciated that the exchange of messages is not limited to one-directional transmission, but includes bidirectional or iterative communication. Therefore, the structured service data is iteratively evaluated by the first agent and the at least one second agent over one or more communication cycles, rather than a single isolated evaluation operation. It may be appreciated that the iterative evaluation may include sending one or more messages, receiving one or more corresponding messages, refining an evaluation based on received information, and performing one or more further evaluation steps until a sufficient collaborative conclusion, namely, consensus, is reached. In this regard, optionally, exchanging messages among the plurality of agents comprises storing structured messages generated by the first and at least one second agents in a collaboration channel data structure of the communication channel and updating a collaboration state data structure based on the structured messages. Beneficially, iterative evaluation improves the robustness and accuracy of collaborative agent decision-making by allowing participating agents to refine interpretation of the structured service data across multiple communication exchanges.

As used herein, the term “consensus” refers to a shared or agreed execution position regarding how execution of the service request is to proceed. The consensus corresponds to a common execution outcome or decision state reached after the iterative evaluation of the structured service data, that is sufficient to permit downstream task execution. In an implementation, when multiple autonomous agents work collectively, different steps are completed by different autonomous agents and the multiple autonomous agents work in consensus to collectively reach a final outcome for achieving the required functionality. The system incorporates a consensus mechanism, that consensus may be recorded as data in the communication channel, and that execution is conditioned on that recorded state. Beneficially, reaching the consensus before execution improves coordination reliability by ensuring that downstream task execution is based on a shared agent-level decision rather than conflicting or uncoordinated agent actions.

A consensus mechanism may be used to ensure that multiple agents operating across different computing nodes converge on a common decision despite message delay, node unavailability, conflicting proposals, or adversarial behavior. In this context, correctness of the consensus process may be characterized by agreement, validity, and termination. Agreement may require that agents that successfully complete the consensus process adopt a common execution result. Validity may require that the agreed result correspond to a proposed execution state, task, or value generated within the system. Termination may require that, under defined operating conditions, the participating agents eventually determine a result or a fallback result.

The system may be configured according to different timing assumptions. In a fully asynchronous environment, message delivery times may be unbounded and no reliable timeout may be assumed. In partially synchronous environments, message delays may be unbounded for a period of time but eventually become bounded, thereby enabling progress after a transient unstable period. In synchronous environments, communication and processing delays may remain within known bounds. A selected consensus mechanism may depend on such timing assumptions. For example, some mechanisms may preserve safety under asynchronous behavior but require partial synchrony, stable leadership, or timeout-based view changes to ensure liveness.

The fault model may distinguish between crash faults and Byzantine faults. Crash faults may correspond to an agent or node ceasing participation or failing silently. Byzantine faults may correspond to arbitrary, inconsistent, malicious, or deceptive behavior, including equivocation, inconsistent proposal dissemination, or contradictory validation messages. Consensus mechanisms selected for the system may therefore vary according to whether the system is intended to tolerate silent failures only or also to tolerate agents that provide conflicting or adversarial behavior. The number or fraction of faulty agents tolerated by a consensus process may be defined by a threshold rule associated with the selected protocol.

In some embodiments, the communication channel used by the agents may support consensus through a structured sequence of protocol phases. Such phases may include, by way of example, a proposal phase, a validation phase, and a commitment phase. In a proposal phase, a first agent or coordinating agent may publish structured service data, a task representation, a proposed execution state, or a candidate ordering to the communication channel. In a validation phase, one or more additional agents may transmit messages indicating support, rejection, dependency information, ordering information, or conflicting state information. In a commitment phase, a consensus state may be detected when messages stored in or transmitted via the communication channel satisfy one or more threshold conditions, after which execution of at least one task may be authorized or triggered.

Consensus may be achieved using quorum-based decision rules. A quorum may correspond to any subset of agents or nodes satisfying a threshold condition, such as a majority, supermajority, weighted majority, or other quorum definition. The principal property of a quorum system may be intersection between quorums, such that conflicting decisions cannot both be finalized without sharing at least one common agent. In crash-fault-tolerant configurations, a quorum may be based on a majority of nodes among a set of 2f+1 nodes to tolerate up to f crashes. In Byzantine-fault-tolerant configurations, a supermajority quorum may be used, such as 2f+1 agents among 3f+1 total agents, thereby ensuring that two conflicting quorums intersect in at least one honest agent. In weighted configurations, quorum participation may be determined by cumulative weight rather than node count.

In some embodiments, quorum participation may be determined based on a weighted contribution associated with one or more agents, wherein the weighted contribution corresponds to at least one of a trust score, authority level, resource contribution, or delegated role of the agent, and wherein a threshold condition is satisfied when a cumulative weight associated with validation messages stored in the communication channel exceeds a predefined value.

The system may use a leader-based or coordinating-agent consensus protocol. The coordinating agent may be responsible for proposing an execution state, assigning an ordering, collecting responses, determining whether a threshold has been reached, and causing execution or fallback execution. The coordinating agent may be statically assigned, dynamically elected, rotated among agents, or replaced when one or more timeout or failure conditions are detected. Leadership replacement may be triggered when insufficient progress is observed, when conflicting proposals occur, or when a coordinating agent fails to provide timely messages in the communication channel.

In some embodiments, leadership replacement or coordinating-agent replacement may be performed in response to detection of insufficient progress within the communication channel, detection of conflicting proposals stored in the communication channel, or absence of required messages within a predefined interval, wherein such detection is based on evaluation of messages and state updates stored in the communication channel.

A crash-fault-tolerant protocol analogous to Paxos may be used in some embodiments. Under such an approach, a proposing agent may transmit a first proposal message associated with a proposal number or ordering identifier. Participating agents may respond with promise messages indicating that lower-priority proposals will not be accepted and, in some implementations, with information regarding previously accepted proposals. If a quorum of promise messages is obtained, the proposing agent may issue an acceptance message for a selected value or execution state. A value may be treated as decided when a quorum of participating agents accepts it. Safety may derive from quorum intersection and from a rule requiring a new proposer to adopt a previously accepted value when such value has already been observed. A stable proposer or leader may be maintained across multiple decisions to reduce protocol overhead.

In some embodiments, ordering information associated with proposals may be represented by sequence identifiers, proposal numbers, or ordering metadata stored in the communication channel, and subsequent proposals may be required to adopt or extend previously stored ordering information based on evaluation of messages already stored in the communication channel.

A crash-fault-tolerant protocol analogous to Raft may alternatively be employed. Under such an approach, a single leader or coordinating agent may receive candidate tasks or commands, append them to an ordered log or equivalent state representation, and replicate them to a quorum of agents or nodes. Commitment may occur after a majority has stored the corresponding entry. Election terms, log matching properties, and up-to-dateness conditions (meaning freshness conditions or recency conditions) may be used to prevent obsolete leaders from being elected and to ensure that conflicting suffixes are overwritten by a valid leader state. Such a protocol may be advantageous in systems in which membership is relatively stable and where a single coordinating agent is acceptable for throughput and control reasons.

A leaderless or reduced-leader protocol may also be used. For example, one or more agents may propose tasks, states, or command dependencies to a fast quorum without requiring a single fixed leader for all decisions. If no conflict is detected among proposals, the proposed action may be committed along a reduced-latency path. If conflicts are detected, the protocol may fall back to an additional coordination or ordering phase to resolve dependencies. Such approaches may reduce bottlenecks in geographically distributed or highly parallel deployments while increasing complexity of dependency tracking and recovery.

The system may employ a Byzantine fault tolerant protocol analogous to PBFT. A designated agent may first issue a pre-prepare or proposal message assigning an order or sequence value to a candidate execution state. Participating agents may then issue prepare or validation messages indicating that the proposed ordering and content are accepted. Once a sufficient number of validation messages have been observed, agents may issue commit messages. Execution may occur only after a required number of matching commit indications has been received. If the designated coordinating agent becomes faulty, slow, or inconsistent, a view-change or leadership-change process may be performed to select a replacement coordinating agent while preserving already prepared or committed state. Such a protocol may be particularly useful in permissioned or consortium-like deployments in which a bounded validator set is known.

A Byzantine fault tolerant protocol analogous to HotStuff or similar quorum-certificate-based protocols may be used in other configurations. Under such approaches, one agent may propose a candidate state extending a highest-known certified state, and other agents may return votes. A quorum certificate may be formed when a threshold number of votes is obtained, and later proposals may build on the highest available quorum certificate. Consensus may be achieved through chained justification, such that one round's certificate contributes to commitment of earlier proposed states. Communication complexity may be reduced relative to older all-to-all protocols by aggregating support into certificates. In some embodiments, the communication channel may store or reference such certificates as evidence that a consensus threshold has been reached.

A round-based protocol analogous to Tendermint may alternatively be used. A proposing agent may issue a proposed execution state; other agents may transmit a first vote message and then a second vote message once sufficient support is observed. A lock rule may prevent an agent from abandoning a supported proposal except under specified conditions in a later round. Deterministic finality may be achieved when a supermajority threshold is satisfied. Such configurations may be useful when the system maintains a bounded participating set and values immediate finality more than tolerance for prolonged temporary divergence.

Consensus may be probabilistic rather than deterministic. For example, a protocol analogous to Proof of Work may be used in open or adversarial environments in which agents or nodes produce candidate blocks, records, or decisions subject to a resource-based or work-based selection rule. Competing branches may exist temporarily, and a preferred branch may be selected according to cumulative difficulty, cumulative work, or another accumulated metric. Finality may then be probabilistic, increasing as additional subsequent confirmations or states accumulate. Although such mechanisms are commonly associated with blockchain systems, the underlying technical concept of probabilistic finality and branch selection may also be adapted to agent-based distributed coordination systems.

Stake-weighted or authority-weighted consensus may be used in some embodiments. A node or agent may be selected to propose or attest to an execution state according to a weighted rule, where weights correspond to stake, trust score, authority level, resource contribution, or delegated role. A finality condition may require support from a supermajority of the total weight rather than from a simple count of agents. Slashing, penalties, revocation, or other deterrent mechanisms may be applied when a participating agent issues conflicting validations. Such weighted consensus may provide improved efficiency over work-based mechanisms while relying on authenticated or registered agents.

Delegated or authority-based variants may also be employed. A subset of agents may be elected, designated, or otherwise approved to participate directly in consensus on behalf of a larger set of agents. Those selected agents may take turns proposing and validating execution states according to a deterministic schedule or governance rule. This may reduce coordination overhead and improve throughput, although it may also reduce distribution and increase the importance of role assignment, voting rules, or governance mechanisms. The system may also use federated trust configurations in which different agents recognize overlapping trusted subsets for consensus formation.

In some embodiments, the system may separate dissemination of candidate data from final ordering or commitment. For example, structured service data, outputs, or task fragments may first be disseminated broadly through the communication channel, while a separate consensus process determines ordering, acceptance, or final execution state. Such decoupling may improve throughput by allowing data propagation and consensus ordering to proceed in parallel. A communication channel may therefore function both as a dissemination medium and as a stateful repository recording which proposals, validations, and commitment records have already been observed.

In some embodiments, consensus may be achieved using sampling-based or committee-based techniques. Rather than requiring all agents to participate in every round, a selected subset or committee of agents may evaluate the structured service data and provide responses. The committee may be fixed, rotating, dynamically selected, or randomly sampled. Alternatively, a node may repeatedly query a sampled subset of peers regarding a preferred execution result, and repeated supermajority support across multiple rounds may lead to acceptance of a proposed outcome. Such metastable or sampling-based approaches may provide low latency and high throughput while accepting probabilistic rather than strictly deterministic convergence properties.

In some embodiments, the communication channel may store proposals, validation messages, votes, acknowledgments, attestations, quorum records, certificates, lock states, timeout states, unresolved tasks, remaining tasks, and consensus outcomes. One or more agents may monitor the communication channel to determine whether a sufficient threshold has been reached, whether a fallback rule should be applied, or whether execution should be triggered. The communication channel may therefore act as a persistent coordination structure that enables multiple agents to read a common consensus state and to update that state as the protocol progresses.

In some embodiments, a completion evaluator module may determine whether execution of a service request has been completed in accordance with one or more predefined completion criteria. Such criteria may include, by way of example, a maximum number of exchanged messages, expiration of a timeout interval, satisfaction of a quorum threshold, detection of a consensus certificate, detection of a finality record in the communication channel, failure to make progress within a defined number of rounds, or satisfaction of a weighted voting condition. If the completion criteria indicate that execution has not been completed, the system may apply a predetermined deterministic rule to select at least one task for execution. The deterministic rule may depend on ordering, priority, node identity, weighted score, list position, or another non-random criterion.

One or more conflicts may arise because multiple agents propose different task orderings, execution states, or outputs corresponding to the same service request. The system may resolve such conflicts using ordering rules, priority values, proposal numbers, sequence numbers, confidence scores, quorum certificates, or other tie-breaking mechanisms. A later proposal may replace an earlier proposal only if it satisfies a predefined superiority condition. View changes, retries, leader changes, or committee reselection may be performed when conflict persists or when a designated coordinating agent fails to make progress.

The system may adaptively select among multiple consensus mechanisms or adjust consensus parameters according to current operating conditions. Such operating conditions may include network latency, number of participating agents, agent trust metrics or validation conditions, degree of distribution, required finality speed, resource constraints, or detected adversarial behavior. Hybrid systems may combine quorum-based voting, coordinating-agent control, committee sampling, weighted validation, probabilistic branch selection, and certificate-based finality. Such adaptability may allow the system to improve throughput, resilience, and execution reliability while preserving correctness of task execution across a distributed population of agents.

The consensus state recorded in the communication channel may therefore define an execution-enabling condition, such that subsequent task execution by at least one execution agent is causally dependent on the agreed execution state established through the consensus mechanism.

In some embodiments, the system further comprises a temporal component implemented by at least one processor of at least one computing node, the temporal component being configured to manage temporal relationships between messages, prompts, events, and state updates stored in the communication channel. The temporal component may be configured to evaluate an ordering of interactions recorded in the communication channel and to control progression of an execution state associated with a service request based on the evaluated ordering. In some implementations, the temporal component determines processing of inputs received during execution of an ongoing task, including determining whether such inputs are incorporated into the ongoing execution, deferred, or used to modify the execution state. Optionally, execution of at least one task corresponding to structured service data is performed based on both a consensus state and a temporally consistent progression of system state as determined from the communication channel.

The temporal component may be implemented by at least one processor of at least one computing node, the temporal component being configured to manage temporal relationships between multiple system events, inputs, states, or outputs, rather than merely reflecting that processing occurs over time. The temporal component may operate in conjunction with the communication channel, which comprises a shared data structure in which interactions are recorded as a sequence of messages, commands, prompts, or events associated with execution of the service request. Such interactions may be associated with a relative ordering within the sequence, and the temporal component may be configured to evaluate such ordering to manage progression of system state stored in the communication channel as new inputs are received and processed. In this manner, the temporal component enables the system to process interactions as part of a sequence of operations represented in the communication channel, wherein progression of execution of the service request is controlled based on the temporal ordering of messages and state updates.

The temporal component may further be configured to evaluate temporal relationships between multiple prompts and one or more ongoing tasks corresponding to the structured service data, including scenarios in which a first prompt initiates a long-running task and one or more subsequent prompts are received while the long-running task is still being processed.

The temporal component may determine processing of such subsequent prompts relative to the ongoing task, including handling prompts received during execution of the long-running task without requiring termination of that task. In some implementations, the temporal component determines whether a subsequently received prompt is to be incorporated into an ongoing execution, deferred for later processing, or used to modify a current execution state stored in the communication channel. For example, the temporal component may determine incorporation of additional prompts into execution of the task or generation of intermediate outputs prior to task completion, thereby enabling handling of prompts relative to a current execution state.

In some embodiments, the temporal component may maintain or access state information associated with execution of tasks across multiple interaction intervals, including information derived from prior prompts, intermediate outputs, previously executed commands, messages stored in the communication channel, and recorded consensus or execution states. This state information may be stored in association with the communication channel as part of the shared data structure and may be used to evaluate newly received inputs relative to a current execution state of an ongoing task. In this manner, the temporal component may determine system behavior based on both prior interactions and current inputs, thereby supporting persistence and progression of task-related state over time across multiple interaction intervals.

Additionally, the temporal component may enable event-driven response among multiple agents or system elements based on temporal relationships between events stored in the communication channel. For example, at least one agent may monitor the communication channel and determine whether to act in response to messages, commands, prompts, or state updates appended to the communication channel, wherein such determination is based at least in part on the ordering or sequence of those events and on detection of predefined events including newly stored messages, updates to a consensus state, or changes in an execution state. The temporal component may further manage progression of execution state stored in the communication channel through a plurality of state transitions corresponding to the ordered sequence of interactions, wherein each state transition is triggered by at least one message or event stored in the communication channel. The temporal component may thus support workflows in which multiple agents participate in execution of tasks that evolve through sequences of interactions, including multi-stage or concurrently executing tasks, based on temporal ordering and state progression represented in the communication channel.

Accordingly, execution of the at least one task may be controlled not only by the consensus state but also by the temporal ordering and progression of messages and state updates stored in the communication channel, such that execution reflects both agreement among agents and temporally consistent system state evolution

The system further comprises at least one execution agent of the plurality of agents configured to execute at least one task corresponding to the structured service data in response to the consensus. As used herein, the term “at least one execution agent” refers to one or more agents of the plurality of agents configured to perform execution of at least one task associated with fulfillment of the service request. The at least one execution agent may be the first agent, the at least one second agent, another agent of the plurality of agents, or any combination thereof, provided that the at least one execution agent performs execution of the at least one task corresponding to the structured service data in response to the consensus reached by the first agent and the at least one second agent. Beneficially, performing execution in response to the consensus improves coordination reliability by reducing premature, conflicting, or inconsistent task execution among the plurality of agents.

Optionally, the at least one task may comprise one or more machine-implementable units of work selected from at least one of: a service operation, processing operation, retrieval operation, transformation operation, communication operation, update operation, or another execution-relevant activity represented by, derived from, or associated with the structured service data.

Moreover, at least one agent of the plurality of agents is configured to generate an output from the executed at least one task; and update the communication channel based on the output to record completion of the at least one task, thereby fulfilling the service request.

In this regard, the term “output” refers to data or execution result produced from execution of the executed at least one task. Optionally, the output may comprise structured data representing at least one of: data, a response, a status-bearing result, a completed service action, a completed task state, a returned result set, a generated artifact, a workflow transition, a summarized outcome, or another machine-actionable execution result derived from the executed at least one task. Beneficially, generating the output converts execution of the at least one task into a machine-recognizable result that can be recorded, communicated, and used to complete fulfillment of the service request.

The output is subsequently used to update the communication channel. Optionally, updating refers to modifying, recording into, appending to, or otherwise changing data associated with the communication channel to reflect an execution outcome associated with the service request. The update of the communication channel may comprise storing the output, storing completion information, changing a status value, recording a completion event, recording a consensus state, recording metadata associated with the output, or changing channel-associated data to reflect post-execution state. Moreover, generation of the output and update of the communication channel to record completion of the at least one task collectively bring about fulfillment, completion, or machine-recognizable satisfaction of the service request. Beneficially, updating the communication channel provides a shared and machine-readable execution record that improves coordination continuity, state visibility, and traceability across the plurality of agents.

In some embodiments, the service request originates from a client device and wherein the service request comprises unstructured input comprising natural language input. The client device refers to a computing device executing the software application, or a software module executing within a distributed computing environment, cloud infrastructure, or other computing platform. Optionally, the client device may comprise a user-operated device, such as a smartphone, laptop computer, tablet computer, desktop computer, or another networked endpoint configured to provide input to the distributed computer system. It may be appreciated that the client device is the source from which the service request is provided to the first agent or another receiving component of the system. Subsequently, the service request may be transmitted from the client device to one or more computing nodes of the distributed computer system over the communication network.

The term “unstructured input” as used herein refers to input that does not conform to a predefined machine-readable schema, rigid field format, or fixed data structure. The unstructured input may typically include free-form textual expressions, conversational statements, mixed descriptive phrases, or other content not yet normalized into the structured service data. Such unstructured input or service request is transformed or processed by the LLM into the structured service data for execution of the service request. In this regard, the LLM is configured to extract relevant details from the ordinary-language request, and the request is transformed into structured service data or an objective suitable for downstream processing by the plurality of agents. This results in a concrete input-processing pipeline in which free-form human-language content is accepted at intake and then converted into execution-ready structured service data, thereby improving accessibility without sacrificing machine-processable downstream orchestration. Beneficially, the system can ingest human-authored request content from the client device in a flexible non-schema-constrained form and can then process that content through the at least one LLM into the structured service data used for multi-agent collaboration and execution.

In some embodiments, the system further comprises a completion evaluator module configured to use at least one large language model (LLM) to determine whether execution of the service request has been completed in accordance with one or more predefined completion criteria, and wherein the predefined completion criteria comprise at least one of: a maximum message count within the communication channel or a timeout condition. Herein, the term “completion evaluator module” refers to a processor-executable functional component configured to evaluate whether execution of the service request has reached a completion state within the system. The completion evaluator module performs an evaluative control function after or during message exchange among the first agent and the at least one second agent, and before or in connection with subsequent execution-flow decisions affecting fulfillment of the service request. The completion evaluator module fetches from the communication channel message activity and execution-progress context based on which completion may be assessed. The completion evaluator module uses (calls, invokes or apply) the at least one LLM to make the completion determination by evaluating whether the collaborative process associated with the service request has reached a sufficient state for completion of execution. In this regard, the completion evaluator module is configured to compare structured messages and collaboration state stored in the collaboration channel with predefined completion criteria to identify whether the objective has been achieved. Optionally, the completion determination may be indicated via a binary result, a status value, a completion flag, or any other machine-readable output. Beneficially, the completion evaluator module provides a dedicated control mechanism for assessing completion of execution of the service request, thereby improving reliability of multi-agent orchestration by enabling system-level completion assessment rather than leaving completion to ad hoc agent behavior.

In some embodiments, execution of the at least one task is initiated in response to detecting a predefined state condition in the communication channel, wherein the predefined state condition corresponds to the recorded consensus or an execution-ready state stored in the shared data structure of the communication channel. The at least one execution agent may monitor the communication channel for the predefined state condition and initiate execution only upon detection of the predefined state condition.

The term “predefined completion criteria” refers to one or more completion criteria established before the completion determination is made for assessing whether execution of the service request should be regarded as completed. Optionally, the one or more predefined completion criteria may be stored as rules, thresholds, parameters, or other machine-readable evaluative conditions associated with the communication channel, the service request, or the collaboration flow. Optionally, the predefined completion criteria may include quantitative criteria, temporal criteria, semantic criteria, or combinations thereof, provided that the predefined completion criteria are usable to support the completion determination.

More optionally, the predefined completion criteria comprise the maximum message count criterion that depends on message activity occurring within the communication channel. Herein, the term “maximum message count” refers to a predefined numerical threshold corresponding to a count of messages exchanged, stored, transmitted, or associated with the communication channel during iterative evaluation of the structured service data, based on which the completion evaluator module may determine that execution of the service request should be evaluated as completed or should otherwise trigger a completion-related decision. Beneficially, using the maximum message count as a predefined completion criterion provides a bounded communication-control mechanism that limits indefinite iteration and improves computational predictability.

Additionally, the predefined completion criteria comprise the timeout condition. Herein, the term “timeout condition” refers to a predefined temporal condition specifying that, after expiration of a defined period associated with at least execution of the service request, message exchange, or collaboration within the communication channel, the completion evaluator module performs or updates the completion determination. Beneficially, using the timeout condition as a predefined completion criterion prevents unbounded execution duration and improves responsiveness of the distributed computer system in cases of prolonged or stalled collaboration.

In some embodiments, the at least one execution agent is configured to cause execution of the at least one task corresponding to the structured service data using a predetermined deterministic rule when the one or more predefined completion criteria indicate that execution of the service request has not been completed. Herein, the term “predetermined deterministic rule” refers to a rule established and applied in a reproducible manner so that the same relevant execution state yields the same fallback execution decision. The predetermined deterministic rule may govern selection, prioritization, ordering, or continuation of execution of the at least one task or one or more remaining task steps corresponding to the structured service data. In this regard, the predetermined deterministic rule is applied when the one or more predefined completion criteria indicate that execution of the service request has not been completed. For example, the predetermined deterministic rule is such as odd/even ordering, first-or-last option selection, or selection based on the lowest or highest participant identifier. In an example, after message exchange, three remaining task options are still unresolved: Option 1: book Restaurant A at 7:00 PM, Option 2: book Restaurant B at 7:30 PM; and Option 3: book Restaurant C at 8:00 PM. If the predetermined deterministic rule says “when agreement is not reached, select the remaining option in an odd-numbered position”, the system may choose Option 1 or Option 3, depending on the precise rule definition.

Beneficially, the predetermined deterministic rule provides a bounded and reproducible fallback execution mechanism that improves predictability and avoids indefinite deadlock in multi-agent collaboration.

The first agent may operate as a coordinating (i.e. orchestrating) agent configured to divide the service request into task components based on the structured service data and to invoke the at least one second agent or at least one execution agent to execute the at least one task corresponding to the structured service data.

In some embodiments, execution of the service request is further managed in conjunction with a completion evaluator module configured to determine whether execution has been completed based on state information stored in the communication channel.

When the completion evaluator module determines that execution of the service request has not been completed, one or more remaining tasks corresponding to the structured service data are identified and subjected to further collaborative evaluation by the plurality of agents via the communication channel to reach a consensus on execution of the remaining tasks. Upon reaching the consensus, hierarchical delegation of execution of the remaining tasks may be performed. In this regard, at least one agent selected based on the consensus is configured to decompose a remaining task into one or more sub-tasks and to invoke one or more additional agents, including specialist execution agents, to execute the one or more sub-tasks. Each invoked agent may further decompose its assigned sub-task into additional sub-tasks and invoke further agents, thereby forming a multi-level delegation structure in which execution responsibilities are distributed across a hierarchy of agents.

The execution results generated by the plurality of agents at different levels of the hierarchy are returned to the communication channel and combined to form one or more intermediate outputs corresponding to the remaining tasks. The completion evaluator module is then configured to evaluate whether execution of the service request has been completed based on the updated communication channel state. When the completion evaluator module determines that execution has been completed, a collaboration record comprising execution results and associated state information is stored in the communication channel. When the completion evaluator module determines that execution has not been completed, the system applies a predetermined deterministic rule to select at least one of the remaining tasks or execution outcomes, after which the selected task is executed and the completion evaluator module is invoked again. This process is iteratively repeated until the completion evaluator module determines that execution of the service request has been completed.

Herein, the term “coordinating agent” refers to an agent of the plurality of agents that performs a task-management and delegation function for the service request by dividing the service request into task components based on the structured service data and invoking the at least one second agent or the at least one execution agent to execute the at least one task corresponding to the structured service data. Optionally, the coordinating agent is the first agent that in addition to receiving the service request, calling the at least one LLM, and invoking the at least one second agent through the communication channel, performs a coordination role for decomposition and downstream allocation of execution responsibility.

Herein, the term “task components” refers to constituent execution units derived from the service request by decomposition, of the at least one task corresponding to the structured service data, performed by the coordinating agent, that can be handled individually or in combination during execution. The task components may correspond to two or more constituent parts, sub-requests, sub-tasks, execution segments, intermediate execution segments, partial execution objectives, specialist work items, or other machine-usable units of work that collectively contribute to fulfillment of the service request. The first agent, operating as the coordinating agent, may allocate the task components to one or more participating agents, selected from the at least one second agent or at least one execution agent, according to execution suitability, specialization, or availability, and may invoke the at least one second agent or the at least one execution agent so that execution of the at least one task proceeds within the overall multi-agent orchestration flow. It may be appreciated that every task component may be executed by same or different specialist agents, selected from the at least one second agent or at least one execution agent, so invoked for execution participation. Beneficially, by enabling the first agent to perform both decomposition of the service request and invocation of downstream agents for execution, the system improves coordination continuity between request intake, task allocation, and execution of the at least one task corresponding to the structured service data. Moreover, representing the service request as the task components creates machine-usable sub-units that support controlled delegation and more efficient distribution of execution responsibilities among participating agents, thereby improving flexibility and specialization in multi-agent task handling.

In some embodiments, at least one agent comprises an identifier stored in a memory of at least one computing node. The term “identifier” refers to a unique value for each agent of the plurality of agents, comprising the first agent, the at least one second agent, the at least one execution agent, and so on. Optionally, the identifier may comprise an alphanumeric value, handle, address, key, token, label, or other machine-readable identity value associated with the agent. It may be appreciated that identifiers uniquely or sufficiently distinguishes an agent from one or more other agents for storage, lookup in the memory or a database of agents, matching, invocation, or execution coordination within the system, and enable attribution of the task to a specific autonomous agent.

Herein, the term “memory” refers to a storage resource associated with the at least one computing node in which data associated with the at least one agent may be stored. The memory may comprise volatile memory, non-volatile memory, persistent storage, cache memory, database-backed storage, or another machine-readable storage structure accessible by the at least one computing node. Beneficially, the memory provides node-associated storage for the identifier, thereby supporting persistent retention of agent identity data and reliable access to the identifier during agent-identification operations.

Beneficially, the system maintains persistent, node-associated identity data for the at least one agent, thereby enabling deterministic agent representation and supporting later matching, discovery, and execution-control operations based on the identifier. Additionally, the identifier provides a machine-readable identity reference for the agent, thereby enabling deterministic storage, retrieval, matching, and downstream agent identification within the system.

In some embodiments, at least one agent of the plurality of agents is configured to identify one or more agents by matching the identifier comprised in the structured service data with the identifier stored in the memory of at least one computing node. Here, the one or more agents are identified for participation in execution of the service request. In this regard, the system is configured to determine a specific target agent, a subset of candidate agents, or one or more participating agents associated with execution of the service request, based on the identifier comprised in the structured service data. It may be appreciated that the identifier of the structured service data provides the identity-bearing information used for identification of the one or more agents from the memory of the computing node. Optionally, the matching may comprise exact comparison, normalized comparison, canonicalized comparison, or another machine-implemented identifier comparison procedure, provided that the matching determines whether the identifier in the structured service data corresponds to the identifier stored in memory. Subsequently, the identified one or more agents participate as appropriate participating agents for downstream invocation, coordination, or execution within the system. Beneficially, matching the identifier in the structured service data with the identifier stored in the memory of the plurality of computing nodes creates a concrete machine-implemented lookup path from request-derived execution data to stored agent identity data, thereby providing deterministic identity-resolution mechanism that supports reliable downstream agent invocation and coordination.

In some embodiments, at least one agent of the plurality of agents is configured to identify one or more agents by searching an agent registry or by querying a distributed agent network. Herein, the term “agent registry” refers to a software-implemented component comprising a database that stores records for plurality of agents. The agent registry may store agent identity data, capability metadata (e.g., supported tasks, protocols, availability, and optional performance or pricing attributes), addressing data, status data, or other registry data, which may be used to locate and identify one or more agents. The agent registry may be implemented as a data structure, repository, database, index, or other machine-readable registry that stores information about one or more agents available to the system for identification, lookup, invocation, or execution coordination within the system or an associated platform environment. Beneficially, the agent registry ensures a structured local-discovery mechanism for resolving agent identity without immediately requiring broader network search, thereby improving efficiency and reducing unnecessary external queries.

Herein, the term “distributed agent network” refers to a network-accessible, distributed environment that includes information about one or more agents beyond the agent registry. The distributed agent network is distinct from the local agent registry in that the distributed agent network provides a broader discovery space that is not limited to locally maintained registry data. Thus, the distributed agent network increases coverage and improves identification of one or more agents across distributed environments.

It may be appreciated that preferably the at least one agent of the plurality of agents is configured to identify one or more agents by searching the agent registry prior to querying the distributed agent network as a fallback only if no local match is found. In other words, the system comprises identifying an agent referenced in the service request by searching the local agent registry and, when the agent is not found in the local agent registry, querying the distributed agent network. Said staged design enables the system to avoid unnecessary distributed agent network queries when a suitable agent is already known locally in the agent registry. Moreover, by enabling identification of one or more agents through local agent registry search or distributed-network query, the system provides flexible and robust discovery mechanisms for downstream invocation and orchestration of agent participation. For example, the system may first search a local twin table by agent address, then by handle, then by UUID, and only if no local match is found the system may query the external distributed agent network, such as Agentverse API.

In some embodiments, at least one agent of the plurality of agents is configured to update the communication channel to record the consensus. Herein, the communication channel is modified or updated to reflect, store, or carry machine-readable data indicating that the consensus has been reached. The update may comprise adding a new channel entry, modifying channel state data, storing a structured consensus message, updating a consensus-status field, or changing channel-associated data to reflect the consensus state. It may be appreciated that the consensus arises from the message exchange and is then recorded in the communication channel as a result of the update. This creates a persistent and shared coordination state that can be accessed by participating agents, thereby improving consistency between collaborative evaluation and subsequent execution behavior. Beneficially, representing the consensus as channel state enables subsequent agents or execution logic to detect a shared completion-of-agreement condition from the communication channel itself, thereby improving state visibility and execution gating.

In some embodiments, at least one agent of the plurality of agents is configured to trigger execution of the at least one task in response to an update of the communication channel. In this regard, the at least one agent initiates or causes commencement of execution of the at least one task based on a defined communication channel update, such as an update that records the consensus, an update that reflects execution readiness, or another machine-readable update associated with progression of the orchestration flow. Herein, the updated state of the communication channel operates as a condition precedent or execution-enabling event for initiation and execution of the at least one task. Beneficially, the system uses shared channel-state changes as machine-detectable execution triggers, thereby improving synchronization between recorded orchestration state and downstream task execution, and preserving continuity between message-based collaboration and execution control.

Optionally, the system further comprises using at least one processor to generate a task-to-agent mapping stored in memory or in a data repository. Herein, each task comprises an identifier, namely the task identifier. The term “task identifier” refers to a unique value (e.g., alphanumeric ID, hash, or GUID) assigned to a task specification to distinguish the task from other tasks and enable tracking. Moreover, mapping task-to-agent records the identifier of the autonomous agent selected to execute that task corresponding to the mapped task identifier. Additionally, the system is further configured to update a state value of the task identifier to indicate it is assigned and generating a structured invocation instruction for the autonomous agent to execute the task. The stored mapping is used by the at least one processor to control subsequent execution of the task by the selected autonomous agent, thereby enabling deterministic task execution, controlled coordination among agents, and consistent execution of the task across a plurality of problem domains.

Optionally, the first agent employs an invocation module that receives, from an orchestration module of the at least one processor, a signal indicating that at least one task has been determined and that at least one second agent or at least one execution agent has been assigned to each task. Optionally, such signal may comprise a message, function call, event, or other inter-process notification including task identifiers and task-to-agent assignment data. Upon receipt of the signal, the invocation generator module generates at least one task specification for execution of each task by the at least one autonomous agent assigned to the task, wherein the task specification defines executable parameters including, for example, an operation identifier, required inputs, constraints, expected outputs, sequencing requirements, and/or references to authorized resources. Optionally, the task specification is generated using a structured invocation format, such as a schema-defined data object (e.g., JSON) having predetermined fields for the task identifier, argument names and types, validation rules, and execution context.

Optionally, the orchestration module is further configured to selectively enable communication between the client agent and autonomous agents associated with the objective while block communication signals between the first agent and autonomous agents that are not associated with the objective. In this context, blocking communication signals comprises programmatically restricting message routing, API calls, network transmissions, or inter-process communications such that only autonomous agents assigned to tasks corresponding to the objective are permitted to exchange data with the first agent. The orchestration module may implement such restriction by updating access control lists, filtering message queues, enforcing authorization tokens or cryptographic keys, or applying policy-based routing rules within the communication layer. The technical advantage is improved execution integrity and resource efficiency by ensuring that only task-assigned autonomous agents participate in service fulfilment while preventing unauthorized or irrelevant inter-agent interactions. In this regard, the orchestration module is further configured to obtain the list of the plurality of autonomous agents from the agent registry or the distributed agent network, for systematic determination of suitable agents, having required capabilities, for task execution.

Optionally, upon completion of a task by the at least one execution agent, the at least one processor is further configured to generate a task completion record stored in the memory of the plurality of computing nodes. Optionally, the task completion record comprises an identifier of the completed task and an identifier of the at least one autonomous agent that performed the task. Herein, the task completion record is a machine-readable entry that memorializes execution of a task and includes at least an identifier of the completed task and an identifier of the at least one autonomous agent that performed the task. Moreover, the at least one processor is further configured to generate the record by receiving a completion signal and output data from the at least one execution agent, extracting the relevant identifiers from the task specification and task-to-agent mapping, and writing the record to the memory (optionally with a timestamp and execution status). Herein, the phrase “timestamp for the task execution” refers to a recorded time value (e.g., start time and/or completion time) generated from a system clock or trusted time source to order execution events and derive latency metrics.

Optionally, the at least one processor is further configured to generate an audit log of actions taken by the at least one execution agent during execution of each task by capturing task execution events and storing corresponding log entries in the memory of the plurality of computing nodes. Optionally, each entry comprises at least one of: the task identifier, the agent identifier, and/or a timestamp for the task execution. This is performed to provide traceability and post-execution verification of multi-agent task performance. The term “audit log” refers to a machine-readable record that stores, for a service request, a chronological sequence of execution events indicating actions performed during task execution, optionally including task identifiers, performing agent identifiers, timestamps, and execution status. In some embodiments, the audit log is stored as an immutable record in the memory using append-only, tamper-evident storage semantics. The audit log is cryptographically linked to the at least one execution agent by storing a execution agent identifier with a cryptographic hash and/or digital signature computed over the audit log contents and the execution agent identifier, such that any post-recordation modification causes a detectable cryptographic mismatch.

The technical advantage the aforementioned approach is improved accountability and tamper-evident traceability of composite execution via structured audit logging.

In some embodiments, the system further comprises:
a relationship classification module configured to classify a relationship between the first agent and an owner associated with an invoked at least one second agent; and
a permission construction module configured to construct a tool access permission set for the invoked at least one second agent based on the classified relationship.

Herein, the term “relationship classification module” refers to a processor-executable functional component configured to determine a relationship category between the first agent and the owner associated with the invoked at least one second agent. In this regard, when an agent, namely a second agent, is invoked, the system determines the social relationship between the invoking user associated with the first agent, and the invoked agent's owner and classifies the relationship into one of multiple tiers.

Herein, classifying a relationship comprises determining and assigning the relationship to a predefined relationship category or tier. The classified relationship may correspond to tiers selected from an owner-level or partner relationship, a family-member relationship, a friend relationship, an authenticated non-related user relationship, or an anonymous relationship. Optionally, the relationship classification module is further configured to link each tier to a different tool-access scope. The classified relationship allows the tool access permission set to be constructed so that the invoked agent has access to the communication channel. Beneficially, classifying the relationship into a defined tier enables deterministic and repeatable selection of an appropriate permission scope for the invoked at least one second agent.

Herein, the owner associated with the invoked at least one second agent refers to a human principal, user account, or other owner entity linked to the invoked at least one second agent and whose relationship to the first agent is used to determine access scope. Beneficially, associating the invoked at least one second agent with an owner enables relationship-aware access control grounded in owner-specific privacy and permission boundaries.

The term “permission construction module” refers to a processor-executable functional component configured to construct or generate the tool access permission set for the invoked at least one second agent based on the classified relationship. The permission construction module uses the classified relationship as the input to determine the scope of the tool access permission set, and applies the constructed tool access permission set to the invoked at least one second agent. The term “tool access permission set” refers to a set of permissions, access rules, filtered tool listings, or capability constraints that determines which tools, integrations, or operations are available to the invoked at least one second agent for the current interaction. For example, the tool access permission set allows full access for the owner/partner tier, read-only or limited integration access for family-member and friend tiers, public-integration-only access for authenticated unrelated users, and minimal tools for anonymous users. Similarly, scheduled prompts, agent discovery tools, and collaboration creation tools may be limited to the owner/partner tier, while web search and image generation may remain available more broadly. Beneficially, the tool access permission set provides fine-grained, interaction-specific capability control for the invoked at least one second agent, thereby protecting sensitive owner-linked tools while preserving useful collaboration.

Optionally, the permission construction module is further configured to assemble or filter the tool access permission set. It may be appreciated that the same agent may behave differently with different agents based on the classified relationship. Beneficially, the permission construction module enables dynamic generation of an access scope tailored to the relationship context, thereby reducing unauthorized access to sensitive tools or data.

In some embodiments, the system is further configured to select, by a speaker selection module associated with the communication channel, a next agent permitted to transmit a message to the communication channel based on parameters stored in the communication channel. As used herein, the term “speaker selection module” refers to a processor-executable functional component configured to determine which participating agent, namely the next agent, is permitted to transmit the next message to the communication channel during the orchestration flow. Optionally, the parameters may comprise message history-derived values, participation status data, completion-progress data, objective-related data, agent-capability-related data, turn-order data, or other information stored in the memory of the communication channel. In this regard, for larger groups, an LLM-based speaker selection module may evaluate conversation context, objective, and capabilities to determine the most appropriate next speaker.

The speaker selection module operates on channel-associated collaboration data and controls transmission thereof into the communication channel. It may be appreciated that the speaker selection module serves as a part of goal-oriented multi-agent conversation management and selects a next digital twin permitted to transmit its structured message to the collaboration channel. Optionally, the speaker selection module may or may not be physically stored inside the communication channel. The speaker selection module reduces uncontrolled message ordering and improving coordination of channel-based interaction. Additionally, selecting the next agent by the speaker selection module imposes ordered participation in the collaboration flow, thereby reducing cross-talk and improving control of multi-agent conversational progression. Therefore, the speaker selection module enables consensus state-aware turn allocation within the communication channel-based multi-agent collaboration system.

In some embodiments, the system is further configured to prevent recursive invocation loops by classifying message sources to exclude agent-generated messages from triggering new agent invocations and classifying message types to allow invocation only for user-originated messages. Herein, the term “recursive invocation loops” refers to repeated or self-propagating invocation of at least one second agent of the plurality of agents in response to messages self-generated by said second agents. By preventing the recursive invocation loops the system avoids unbounded agent-to-agent response cycles within the communication channel. In this regard, the system employs message source classification as one basis for blocking recursive invocation loops. The system implements a defense-in-depth loop prevention mechanism to enable multiple agents to coexist safely in shared communication channels and to prevent infinite loops.

In this regard, the message sources, such as user or an agent-related source are classified by inspecting a source metadata field carried with the message. Optionally, messages originating from agent responses, including owner-sent-as-agent and external agent responses, are classified as agent-originated and excluded from triggering further agent invocations. Preferably, user-originated messages are used for next agent invocation. Hence, message source classification helps in deciding whether a given message is eligible to trigger a new agent invocation.

Moreover, the term “message types” refer to machine-readable classifications indicating the semantic or functional kind of a message. The message types may include user message, response, reasoning, tool call, and tool call result. It may be appreciated that only permitted message types, namely user-originated messages, are allowed to trigger invocation. Optionally, tool call is an excluded agent-generated message type.

Beneficially, by classifying the message sources to exclude the agent-generated messages from triggering the new agent invocations and by classifying the message types to allow invocation only for the user-originated messages, the system applies two independent screening layers before invocation proceeds. It may be appreciated that these layers operate independently and continue to prevent infinite loops even if one layer is bypassed. This results in improved loop safety, reduced recursive agent chatter, and more reliable coexistence of multiple agents within a shared human-facing communication channel.

In a second aspect, the present disclosure further provides a computer-implemented method for orchestrating multi-agent collaboration within a channel-based communication system, the method comprising:
a first agent of a plurality of agents:
   receiving a service request,
   calling at least one large language model (LLM) to generate structured service data for execution of the service request, and
   invoking, via a communication channel, at least one second agent of the plurality of agents using the structured service data;
the first agent and the at least one second agent exchanging messages via the communication channel to iteratively evaluate the structured service data and reach a consensus on execution of the service request;
executing, by at least one execution agent of the plurality of agents, at least one task corresponding to the structured service data in response to the consensus;
generating an output From the executed at least one task; and
updating the communication channel based on the output to record completion of the at least one task, thereby fulfilling the service request.

The present disclosure also relates to the computer-implemented method as described above. Various embodiments and variants disclosed above, with respect to the aforementioned distributed computer system, apply mutatis mutandis to the computer-implemented method.

The computer-implemented method of the present invention comprises all steps the system is configured to execute, as described below and in the appended claims.

The disclosed computer-implemented method or method establishes a clear machine-ingestible starting point for execution of a requested service by employing the first agent as the initiator of the orchestration flow and at least one execution agent as the executor of the service request, while allowing controlled introduction of other participating agents into a shared collaboration context. The method employs the at least one LLM to generate the structured service data for execution of the service request, for later coordination and execution. The method improves robustness of execution planning by deriving the execution decision from iterative multi-agent communication and evaluation rather than a single isolated judgment. Moreover, the method provides a gated transition from collaborative reasoning to task performance, thereby improving sequencing and reducing execution inconsistency. Moreover, the method ensures that the result of execution is both produced and recorded in a shared machine-readable state structure, which is sequentially used to improve the execution of the service request. The synergistic effect provided by the method claim is a closed technical control loop in which the service request is structured, collaboratively evaluated, selectively executed, and persistently recorded through the communication channel. This improves execution accuracy, synchronization of participating agents, and continuity between request intake, execution control, and completion handling in a multi-agent environment.

In some embodiments, the service request originates from a client device, and wherein the service request comprises unstructured input comprising natural language input.

In some embodiments, the method further comprises using, by a completion evaluator module, at least one large language model to determine whether execution of the service request has been completed in accordance with one or more predefined completion criteria, and wherein the one or more predefined completion criteria comprise at least one of: a maximum message count within the communication channel or a timeout condition.

In some embodiments, the method further comprises executing, by the at least one execution agent, the at least one task corresponding to the structured service data using a predetermined deterministic rule when the one or more predefined completion criteria indicate that execution of the service request has not been completed.

In some embodiments, one of the agents operates as a coordinating agent configured to divide the service request into task components and to invoke the at least one second agent or at least one execution agent to execute the at least one task corresponding to the structured service data.

In some embodiments, at least one agent comprises an identifier stored in a memory of at least one computing node.

In some embodiments, the method further comprises identifying one or more agents by matching the identifier comprised in the structured service data with the identifier stored in the memory of at least one computing node.

In some embodiments, the method further comprises identifying one or more agents by searching an agent registry or by querying a distributed agent network.

In some embodiments, the communication channel is updated to record the consensus.

In some embodiments, at least one agent of the plurality of agents is configured to trigger execution of the at least one task in response to an update of the communication channel.

In some embodiments, the method further comprises
classifying, using a relationship classification module, a relationship between the first agent and an owner associated with an invoked at least one second agent; and
constructing, using a permission construction module, a tool access permission set for the invoked at least one second agent based on the classified relationship.

In some embodiments, the method further comprises selecting, by a speaker selection module associated with the communication channel, a next agent permitted to transmit a message to the communication channel based on parameters stored in the collaboration state data structure.

In some embodiments, the method further comprises preventing recursive invocation loops by classifying message sources to exclude agent-generated messages from triggering new agent invocations, and classifying message types to allow invocation only for user-originated messages.

In a third aspect, the present disclosure further provides a non-transitory computer-readable storage medium storing instructions that, when executed by the at least one processor, cause the at least one processor to perform steps of the computer-implemented method of the aforementioned second aspect.

The present disclosure also relates to the non-transitory computer-readable storage medium as described above. Various embodiments and variants disclosed above, with respect to the aforementioned distributed computer system and the aforementioned computer-implemented method, apply mutatis mutandis to the non-transitory computer-readable storage medium.

### DETAILED DESCRIPTION OF THE DRAWINGS

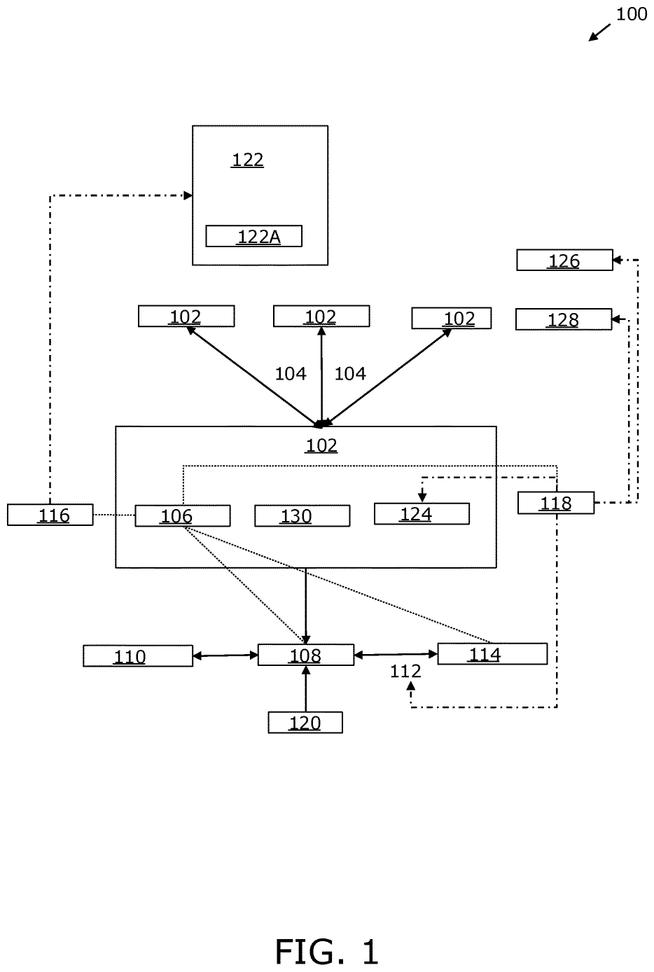

Referring to FIG. 1, illustrated is a block diagram of distributed computer system 100 for orchestrating multi-agent collaboration within a channel-based communication system, in accordance with an embodiment of the present disclosure. As shown, the distributed computer system or system 100 comprises a plurality of computing nodes 102 communicably coupled via a communication network 104, each of the computing nodes 102 comprising at least one agent 106. Moreover, the system 100 further comprises a first agent 108 of a plurality of agents, wherein the first agent is configured to: receive a service request; call at least one large language model (LLM) 110 to generate structured service data for execution of the service request; and invoke, via a communication channel 112, at least one second agent 114 of the plurality of agents using the structured service data. Moreover, the first agent 108 and the at least one second agent 114 are configured to exchange messages via the communication channel 112 to iteratively evaluate the structured service data and reach a consensus on execution of the service request.

Furthermore, the system 100 further comprises at least one execution agent 116 of the plurality of agents configured to: execute at least one task corresponding to the structured service data in response to the consensus, wherein at least one agent 118 of the plurality of agents is configured to: generate an output from the executed at least one task; and update the communication channel 112 based on the output to record completion of the at least one task, thereby fulfilling the service request.

Additionally, as shown, the system 100 further comprises a client device 120. The service request originates from the client device 120, wherein the service request comprises unstructured input comprising natural language input.

Moreover, the system 100 further comprises a completion evaluator module 122 configured to use at least one large language model (LLM) 122A to determine whether execution of the service request has been completed in accordance with one or more predefined completion criteria.

Moreover, the system 100 further comprises a memory 124 associated with at least one computing node 102, wherein at least one agent 118 of the plurality of agents is configured to identify one or more agents by matching the identifier comprised in the structured service data with the identifier stored in the memory 124 of at least one computing node. Additionally, at least one agent 118 of the plurality of agents is configured to identify one or more agents by searching an agent registry 126 or by querying a distributed agent network 128.

Moreover, the system 100 further comprises at least one processor 130 associated with at least one computing node 102.

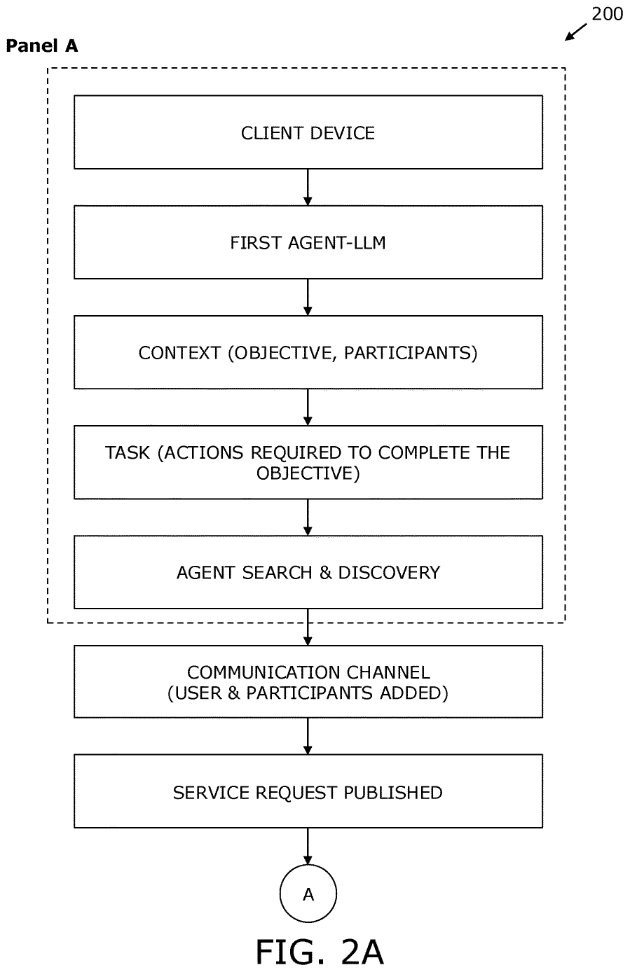

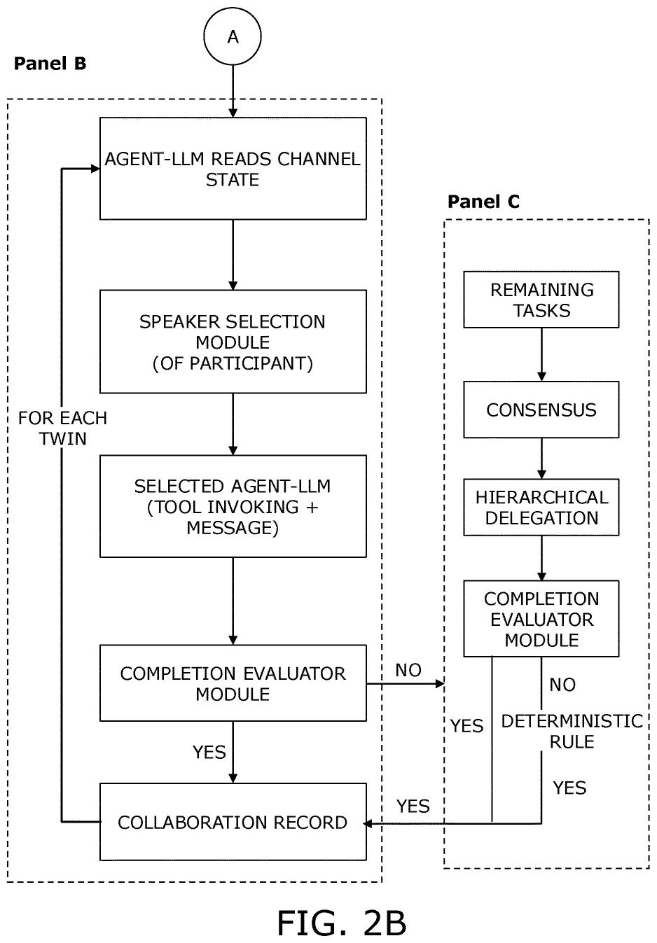

Referring to FIG. 2 (i.e. referring to FIGS. 2A and 2B), illustrated schematic workflow 200 of multi-agent collaboration within a channel-based communication system, in accordance with an embodiment of the present disclosure.

Panel A (within FIG. 2A) shows a Context and Discovery stage of multi-agent collaboration within a channel-based communication system. The Context and Discover stage initiates with a client device or a client-agent device corresponding to a computing node. The client device is associated with an initiator agent, namely the first agent, and is configured to transmit a service request to the first agent. The first agent receives the service request and call at least one large language model (LLM) to process the unstructured service request in natural language to draw context therefrom and generate structured service data therefrom for execution of the service request. Herein, the context corresponds to the objectives associated with the service request and the participating agents comprising the first agent and the at least one second agent communicating over a shared communication channel. The communication channel is used to orchestrate execution of the service request among a plurality of agents. The first agent invokes at least one second agent of the plurality of agents via the communication channel using the structured service data. The invocation introduces one or more participating agents into the collaboration flow for further evaluation and execution of the service request. The first agent and the at least one second agent exchange messages via the communication channel to iteratively evaluate the structured service data. The participating agents reach a consensus on execution of the service request. The consensus may correspond to a shared execution position or agreed execution outcome generated through the iterative message exchange.

Subsequently, at least one execution agent executes at least one task corresponding to the structured service data in response to the consensus. The execution agent may be the first agent, the at least one second agent, or another participating agent, depending on implementation. Execution produces a concrete result associated with fulfillment of the service request. At least one agent generates an output from the executed at least one task. The output may comprise a completed service action, generated data, workflow state, transaction result, or another machine-actionable result corresponding to performance of the at least one task.

Subsequently, the communication channel is updated based on the output to record completion of the at least one task. In this manner, the communication channel stores machine-readable execution progress and completion information associated with the collaboration. Herein, the system employs an agent search and discovery module to search agents using an “@” identifier contained in the user's service request. Optionally, the identifier may comprise agent addresses, handles, and unique identifiers. In this regard, local agent registry and the distributed agent network is queried to discover or identify the agents whose identifier matches the identifier of the service request.

The discovered agents act as potential at least one second agent or at least one execution agent, and are stored in the communication channel. The discovered agents are configured to collaborate in the communication channel. The service request is published and stored in the memory of the computing node corresponding to the communication channel, at the end of the Context and Discover stage.

Panel (within FIG. 2B) B depicts the next stage is the Collaboration Loop stage. The Collaboration Loop stage takes as input the published service request. The LLM reads the updated communication channel state, and applies a speaker selection module to apply a two-layer check to identify a next agent permitted to transmit a message to the communication channel based on parameters stored in the communication channel. The selected next agent's LLM is called to prevent recursive invocation loops by classifying message sources to exclude agent-generated messages from triggering new agent invocations and classifying message types to allow invocation only for user-originated messages by implementing a defense-in-depth loop prevention mechanism to enable multiple agents to coexist safely in shared communication channels and to prevent infinite loops.

Subsequently, a completion evaluator module is employed to use at least one LLM to determine whether execution of the service request has been completed in accordance with one or more predefined completion criteria. If the completion evaluator module determines successful completion of the service request, the collaboration preceding the evaluation and the success results/output are recorded in the memory of the communication channel.

Panel C (within FIG. 2B) illustrates the Incomplete or Unsuccessful completion of the service request. As shown, when the completion evaluator module determines unsuccessful completion of the service request, or indicates that the objectives corresponding to the service request are not met, the remaining tasks are listed and opened for the execution by the at least one execution agent. In this regard, the open at least one remaining task is evaluated by the collaborating agents of the communication channel and when a consensus is reached, the at least one execution agent is invoked. The invoked at least one execution agent divides the at least one task into one or more task components for hierarchical delegation amongst the specialist execution agents. The specialist execution agents employ role-specific tools and knowledge for execution of the at least one task. The specialist execution agents send structured response to the collaborating participants. All delegated tasks are combined into one output and published into the communication channel & stored in memory of the computing node.

Subsequently, a completion evaluator module is employed to use at least one LLM to determine whether execution of the service request has been completed in accordance with one or more predefined completion criteria. If the completion evaluator module determines successful completion of the service request, the collaboration preceding the evaluation and the success results/output are recorded in the memory of the communication channel.

However, if the completion evaluator module again determines unsuccessful completion of the remaining tasks corresponding to the service request, or indicates that the objectives corresponding to the service request are not met, the remaining tasks are listed and opened for the execution by the at least one execution agent. In this regard, predetermined deterministic rule is applied to the remaining tasks. In this regard, the predetermined deterministic rule (e.g., based on odd/even ordering of the remaining options, selecting the first or last remaining options in a list, or an option corresponding to the lowest or highest participant identifier) is used to execute the selected remaining tasks by the at least one execution agent, and once there is successful completion of the service request, the collaboration preceding the evaluation and the success results/output are recorded in the memory of the communication channel.

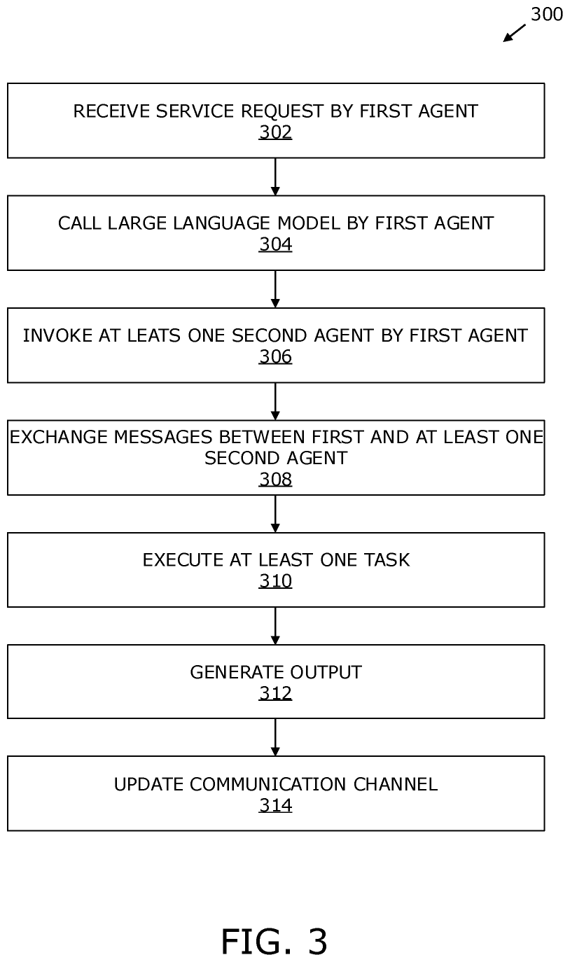

Referring to FIG. 3, illustrated is a flowchart 300 depicting steps of a computer-implemented method for orchestrating multi-agent collaboration within a channel-based communication system, in accordance with an embodiment of the present disclosure, in accordance with an embodiment of the present disclosure. At step 302, a service request is received by a first agent of a plurality of agents. At step 304, at least one large language model (LLM) is called by the first agent to generate structured service data for execution of the service request. At step 306, at least one second agent of the plurality of agents is invoked, via a communication channel, by the first agent using the structured service data. At step 308, messages are exchanged, via the communication channel, between the first agent and the at least one second agent, to iteratively evaluate the structured service data and reach a consensus on execution of the service request. At step 310, at least one task corresponding to the structured service data is executed, by at least one execution agent of the plurality of agents, in response to the consensus. At step 312, an output is generated from the executed at least one task. At step 314, the communication channel is updated based on the output to record completion of the at least one task, thereby fulfilling the service request.

The aforementioned steps are only illustrative and other alternatives can also be provided where one or more steps are added, one or more steps are removed, or one or more steps are provided in a different sequence without departing from the scope of the claims herein.

1. A distributed computer system for orchestrating multi-agent collaboration comprising a plurality of computing nodes communicably coupled via a communication network, each of the computing nodes comprising at least one agent, the system further comprising:
a first agent of a plurality of agents, the first agent configured to:
receive a service request;
call at least one large language model (LLM) to generate structured service data for execution of the service request; and
invoke, via a communication channel, at least one second agent of the plurality of agents using the structured service data,
wherein the first agent and the at least one second agent are configured to exchange messages via the communication channel to iteratively evaluate the structured service data and reach a consensus on execution of the service request; and
at least one execution agent of the plurality of agents configured to:
execute at least one task corresponding to the structured service data in response to the consensus,
wherein at least one agent of the plurality of agents is configured to:
generate an output from the executed at least one task; and
update the communication channel to record completion of the at least one task using the output.

2. The distributed computer system of claim 1, wherein the service request originates from a client device and wherein the service request comprises unstructured input comprising natural language input.

3. The distributed computer system of claim 1, further comprising a completion evaluator module configured to use at least one large language model (LLM) to determine whether execution of the service request has been completed in accordance with one or more predefined completion criteria, and wherein the one or more predefined completion criteria comprise at least one of: a maximum message count within the communication channel or a timeout condition.

4. The distributed computer system of claim 3, wherein the at least one execution agent is configured to cause execution of the at least one task corresponding to the structured service data using a predetermined deterministic rule when the one or more predefined completion criteria indicate that execution of the service request has not been completed.

5. The distributed computer system of claim 1, wherein the first agent operates as a coordinating agent configured to divide the service request into task components using the structured service data and to invoke the at least one second agent or at least one execution agent to execute the at least one task corresponding to the structured service data.

6. The distributed computer system of claim 1, wherein at least one agent comprises an identifier stored in a memory of at least one computing node.

7. The distributed computer system of claim 1, wherein at least one agent of the plurality of agents is configured to identify one or more agents by matching the identifier comprised in the structured service data with the identifier stored in the memory of at least one computing node.

8. The distributed computer system of claim 1, wherein at least one agent of the plurality of agents is configured to identify one or more agents by searching an agent registry or by querying a distributed agent network.

9. The distributed computer system of claim 1, wherein at least one agent of the plurality of agents is configured to update the communication channel to record the consensus.

10. The distributed computer system of claim 1, wherein execution of the at least one task is triggered in response to a consensus state recorded in the communication channel.

11. A computer-implemented method for orchestrating multi-agent collaboration within a channel-based communication system, the method comprising:
a first agent of a plurality of agents:
receiving a service request,
calling at least one large language model (LLM) to generate structured service data for execution of the service request, and
invoking, via a communication channel, at least one second agent of the plurality of agents using the structured service data;
the first agent and the at least one second agent exchanging messages via the communication channel to iteratively evaluate the structured service data and reach a consensus on execution of the service request;
executing, by at least one execution agent of the plurality of agents, at least one task corresponding to the structured service data in response to the consensus;
generating an output from the executed at least one task; and
updating the communication channel to record completion of the at least one task using the output.

12. The method of claim 11, wherein the service request originates from a client device, and wherein the service request comprises unstructured input comprising natural language input.

13. The method of claim 11, further comprising using, by a completion evaluator module, at least one large language model to determine whether execution of the service request has been completed in accordance with one or more predefined completion criteria, and wherein the one or more predefined completion criteria comprise at least one of: a maximum message count within the communication channel or a timeout condition.

14. The method of claim 13, further comprising executing, by the at least one execution agent, the at least one task corresponding to the structured service data using a predetermined deterministic rule when the one or more predefined completion criteria indicate that execution of the service request has not been completed.

15. The method of claim 11, wherein one of the agents operates as a coordinating agent configured to divide the service request into task components and to invoke the at least one second agent or at least one execution agent to execute the at least one task corresponding to the structured service data.

16. The method of claim 11, wherein at least one agent comprises an identifier stored in a memory of at least one computing node.

17. The method of claim 11, further comprising identifying one or more agents by matching the identifier comprised in the structured service data with the identifier stored in the memory of at least one computing node.

18. The method of claim 11, further comprising:
evaluating, by a temporal component, an ordering of messages and state updates stored in the communication channel; and
controlling progression of an execution state associated with the service request in accordance with the evaluated ordering;
wherein execution of the at least one task is performed in accordance with the progression of the execution state.

19. The method of claim 11, wherein the consensus mechanism comprises at least one of: quorum-based decision rules, leader-based protocols, leaderless protocols, crash-fault-tolerant protocols, Byzantine fault tolerant protocols, weighted or stake-based validation mechanisms, probabilistic consensus mechanisms, committee-based mechanisms, or combinations thereof.

20. A non-transitory computer-readable storage medium storing instructions that, when executed by the at least one processor, cause the at least one processor to perform steps of a computer-implemented method of claim 11.
